(19) United States
(12) Patent Application Publication
(10) Pub. No.: US 2006/0054415 A1
(43) Pub. Date: Mar. 16, 2006

(54) Oil thrower disk

(76) Inventor: Fritz Buhlmaier, Lorch (DE)

Correspondence Address: KLAUS J. BACH, 4407 TWIN OAKS DRIVE, MURRYSVILLE, PA, 15668, US

(21) Appl. No.: 11/215,198

(22) Filed: Aug. 26, 2005

Related U.S. Application Data
(63) Continuation-in-part of application No. PCT/EP04/00997, filed on Feb. 4, 2004.

(30) Foreign Application Priority Data
Feb. 27, 2003 (DE) 103 08 367.7

(51) Int. Cl. F16N 7/28

(52) U.S. Cl. 184/11.1

(57) ABSTRACT

In an oil thrower disk, which has a plurality of recesses at arranged in its circumferential area which forms an immersion part, the thickness D of the oil thrower disk is smaller at the immersion part than in the center of the oil thrower disk so as to avoid interference between the oil thrown off the oil thrower disk with adjacent components.

This is a Continuation-In-Part application of International Application PCT/EP2004/000997 filed Feb. 4, 2004 and claiming the priority of German application 103 08 367.7 filed Feb. 27, 2003.

### BACKGROUND OF THE INVENTION

The invention relates to an oil thrower disk which is mounted on the shaft of a transmission and has an immersion part formed in the peripheral area of the oil thrower disk.

A thrower disk for lubricant is already known for example from EP 0 224 740 A1. In this case, the thrower disk is arranged on a rotor shaft in an oil-filled side space of a piston vacuum pump. The thrower disk has a radially inwardly open peripheral channel which is provided with a plurality of spray openings.

It is the object of the present invention to provide an oil thrower disk in such a way that its use in a restricted construction space is facilitated.

### SUMMARY OF THE INVENTION

In an oil thrower disk, which has a plurality of recesses at arranged in its circumferential area which forms an immersion part, the thickness D of the oil thrower disk is smaller at the immersion part than in the center of the oil thrower disk so as to avoid interference between the oil thrown off the oil thrower disk with adjacent components.

This ensures that the oil thrower disk picks up lubricant under very narrow construction-space conditions by way of the narrow immersion part and delivers the lubricant to bearing points arranged radially relative to the oil thrower disk.

To this end, it is advantageous if the peripheral region and/or the immersion part becomes narrower in the radial outward direction. The transition between the oil thrower disk and the narrower immersion part may also be continuous, so that the lubricant picked up in the lubricant sump is not subjected to any separation edge during the radial outward flow thereof.

In a particular embodiment, the peripheral region is in radial alignment with a first side or a second side of the oil thrower disk or is arranged offset relative to both sides. Depending on the application, the oil thrower disk is narrowed down in the region of the immersion part only on one side or on both sides, thereby resulting in corresponding effects on the effective spray plane of the oil thrower disk.

Furthermore, it is advantageous if the immersion part, has at least one recess or several recesses which are arranged evenly distributed over the circumference in the peripheral region and whose radial extent corresponds approximately to the radial extent of the immersion part and whose axial extent is at least 5% of the thickness D of the oil thrower disk. The axial extent T of the recess must be at least so large that a corresponding lubricant film can be formed when the recess passes through the lubricant sump, and the lubricant film is not prematurely wiped off or impaired, on account of the narrow construction-space conditions, in the region of other transmission elements bearing against a side of the oil thrower disk. Depending on the size of the oil thrower disk and depending on the viscosity of the lubricant used, this axial extent T is to be set in accordance with the lubricant quantity to be delivered.

It is also advantageous in this respect if the recesses are arranged on the first and/or the second side so as to be offset circumferentially from one another. The offset arrangement of the recesses distributed over the circumference ensures a sufficient and virtually constant lubricant delivery flow. In this case, the number of recesses on both sides varies between 3 and 300, depending on the size of the recess, the size of the oil thrower disk and the magnitude of the lubricant flow to be delivered.

Of particular importance for the present invention is the fact that the immersion part has at least one lug projecting radially outward with respect to the peripheral circle. The lug projecting outward ensures a common collecting and release point for the lubricant over the periphery of the oil thrower disk. Depending on the viscosity and on the speed of the oil thrower disk, a precise separation instant for the lubricant can be achieved by the design of the lug shape form. In this case, the oil thrower disk has a constant peripheral line in the region of the lug, so that the flow process of the lubricant is ensured.

In connection with the design and arrangement according to the invention, it is advantageous if at least one guide groove arranged on at least one side and intended for use with lubricant is assigned to the immersion part and/or the lug. The guide grooves ensure additional wetting of the dip part with lubricant. In this case, the guide grooves may have a wide variety of widths or depths or also cross-sectional shapes, so that, depending on the oil viscosity and on the transmission speed, optimum wetting of the oil thrower disk with lubricant and thus a sufficient lubricant flow are ensured.

Furthermore, it is advantageous if at least two guide grooves have a common outlet point, the outlet point being preferably arranged at the radially outer end of the lug.

In addition, it is advantageous if the immersion part has a rough, textured surface providing for an increased thickness of the lubricant film. The rough or textured design of the surface of the lubricant thrower disk ensures optimum wetting of the latter and thus an optimum lubricant flow.

Furthermore, it is advantageous if the guide groove is oriented in the radial direction, in the peripheral direction and/or in accordance with the contour of the peripheral circle. The shape and the orientation of the guide grooves promote on the one hand the wetting action by means of the lubricant and on the other hand the flow process over the immersion part of the lubricant thrower disk up to a release point or a separation edge for the lubricant.

The invention will become more readily apparent from the following description of preferred embodiments thereof with reference to the accompanying drawings.

### BRIEF DESCRIPTION OF THE DRAWINGS

FIG. 1 is a side view of an oil thrower disk with recesses;

FIG. 1b is a sectional illustration of the oil thrower disk of FIG. 1;

FIG. 2 is a side view of an oil thrower disk with recesses and lugs, and

FIG. 3 is a sectional illustration of a transmission with oil thrower disk.

### DESCRIPTION OF PARTICULAR EMBODIMENTS

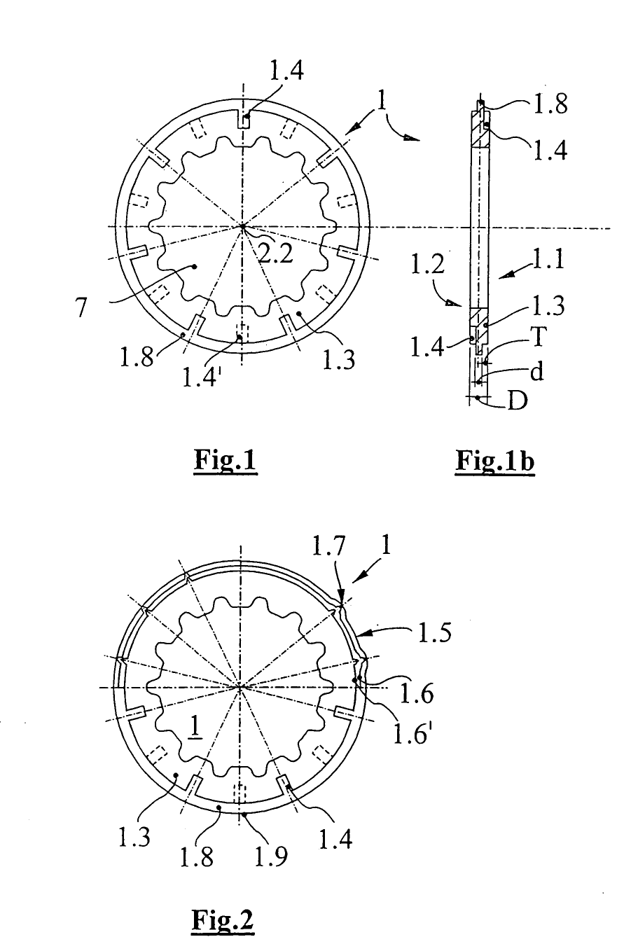

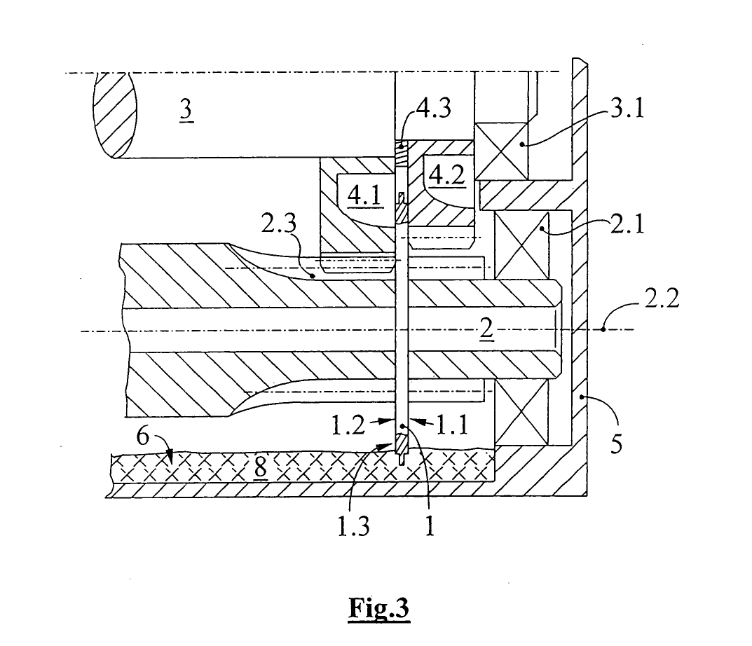

The oil thrower disk 1 according to FIG. 1 has a basic circular shape, with a central opening having a plurality of inner recesses 7. The circular oil thrower disk 1 thus formed has an immersion part 1.3 at the outer periphery thereof. Provided inside this annular region are a plurality of outer recesses 1.4, 1.4′ which serve to entrain lubricant when passing through a lubricant sump 6 as shown in FIG. 3. In the radial direction, the recess 1.4 has an extent which corresponds approximately to that of the annular area or of the immersion part 1.3. In this case, the recess 1.4 has a rectangular cross section with respect to the center or longitudinal axis 2.2, the height-to-width ratio being about 2:1.

According to FIG. 1b, the oil thrower disk 1 has an essentially rectangular cross section. Provided at the outer periphery is a circumferential region 1.8, the thickness d of which is about 40% of the thickness D of the oil thrower disk and which has an extent in the radial direction corresponding to the oil thrower disk. The circumferential region 1.8 is likewise rectangular in cross section.

The recesses 1.4, are distributed over the periphery on a first side 1.1 and the recesses 1.4′ are arranged on a second side 1.2 of the oil thrower disk 1 and are circumferentially offset with respect to the recesses 1.4 on the first side 1.1. The rectangular recess 1.4 according to FIG. 1 has an axial depth T which is about 30% of the thickness D of the oil thrower disk 1. In this case, each side 1.1, 1.2 of the oil thrower disk 1 has seven recesses uniformly distributed over the periphery, the recesses 1.4 of the first side 1.1 being arranged circumferentially between the recesses 1.4′ of the second side 1.2.

According to FIG. 2, the oil thrower disk 1 includes furthermore a plurality of guide grooves 1.6, 1.6′ near the outer periphery in the region of the immersion part 1.3. In this case, the guide grooves 1.6 extend circumferentially, that is to say they are oriented in accordance with the outer periphery, all the guide grooves 1.6, 1.6′ having a plurality of common release points 1.7. At the release point 1.7, the guide groove 1.6, which is actually oriented in accordance with the outer periphery, extends radially outwardly, so that lubricant guided therein is thrown off radially outwardly in a defined manner at this release point 1.7 on account of the existing centrifugal forces.

According to FIG. 2, the release point 1.7 is optionally arranged in the region of a curved area or lug 1.5 of the periphery.

Both, the guide grooves 1.6, 1.6′ and the recesses 1.4 and also the circumferential region 1.8 constitute lubricant-receiving means, to which oil or lubricant adheres when this area passes through the lubricant sump according to FIG. 3. The adhering lubricant is sprayed outward by the rotation of the oil thrower disk 1.

FIG. 3 shows a part of a transmission which includes 3 a housing wall 5 in which a first gear shaft 2 is rotatably mounted via an anti-friction bearing 2.1. A second gear shaft 3 is rotatably mounted via an anti-friction bearing 3.1. Here, the first gear shaft 2 is in operative connection with the second gear shaft 3 via a gear 4.1. In this case, the gear 4.1 is rotatably mounted on the second gear shaft 3 and is brought into engagement with further transmission elements via coupling means (not shown). In addition, a further gear 4.2 is rotatably arranged on the second gear shaft 2, this gear 4.2 not being directly in engagement with the first gear shaft 2.

The first gear 4.1 and the second gear 4.2 are spaced apart via a spacer 4.3. The oil thrower disk 1 is arranged on the first shaft 2 in a rotationally fixed manner in a plane corresponding to that of the spacer 4.3, whereby the oil thrower disk 1, by way of its inner multi-tooth profile according to FIG. 1, is in engagement with the tooth flanks 2.3 of the first shaft 2.

Provided in the bottom part of the transmission is a lubricant sump 8, which has a filling level 6. The oil thrower disk 1 is located with its respectively lowest part directly in the lubricant sump 8 and is wetted there with lubricant. In the process, the lubricant adheres to the disk in the region of this immersion part 1.3, that is to say in the circumferential region 1.8 inside the outer recesses 1.4 and inside the guide grooves 1.6. Due to the radially acting centrifugal forces, the lubricant is delivered upward according to FIG. 3 toward the spacer 4.3 or the bearing arrangement of the first gear 4.1 and the second gear 4.2 during rotation of the oil thrower disk, caused by its engagement with the first shaft 2.

What is claimed is:

1. An oil thrower disk (1) for a transmission shaft (2) on which the oil thrower is fastened in the peripheral direction and in the radial direction, said oil thrower disk (1) having an immersion part (1.3) arranged in the region of its circumference, said immersion part (1.3) at the outer circumference of the disk (1) including at least a circumferential area (1.8) with a thickness (d) which is smaller than the thickness (D) of the rest of the oil thrower disk (1).

2. The device as claimed in claim 1, wherein the circumferential area (1.8) which includes the immersion part (1.3) has a shape, which narrows down in cross section in the radially outward direction.

3. The device as claimed in claim 1, wherein the circumferential area (1.8) is disposed axially between the opposite first and second sides of the oil thrower disk (1) in alignment with one of the first side (1.1) and the second side (1.2), or offset between both sides (1.1, 1.2).

4. The device as claimed in claim 1, wherein the immersion part (1.3) is provided, distributed over the periphery, with recesses (1.4) in the circumferential area (1.8), said recesses (1.4) having a radial extent (T) which corresponds approximately to the radial extent of the immersion part (1.3) and whose axial thickness is at least 5% of the thickness (D) of the oil thrower disk (1).

5. The device as claimed in claim 4, wherein the recesses (1.4) are arranged at least at one of on the first and the second side (1.1, 1.2).

6. The device as claimed in claim 4, wherein the recesses (1.4) are arranged on the first and the second side (1.1, 1.2) of the oil thrower disk (1) so as to be offset from one another with respect to the circumferential direction.

7. The device as claimed in claim 1, wherein the immersion part (1.3) has at least one lug (1.5) projecting radially outwardly with from the circumference of the disk (1).

8. The device as claimed in claim 1, wherein at least one guide groove (1.6) is arranged on at least one of the sides (1.1, 1.2) of the disk (1) in the immersion part (1.3) of the disk (1).

9. The device as claimed in claim 1, wherein at least two guide grooves (1.6) are joined in a common release point (1.7), the release point (1.7) being arranged at the radially outer end of the lug (1.5).

10. The device as claimed in claim 1, wherein the immersion part (1.3) has a rough, textured surface providing for an increase of thickness of the lubricant film adhering to the surface.

11. The device as claimed in claim 9, wherein the guide groove (1.6) is oriented in one of a radial direction, a peripheral direction and the direction of the contour of the circumference of the disk (1).
